(19) United States
(12) Patent Application Publication
(10) Pub. No.: US 2004/0220897 A1
(43) Pub. Date: Nov. 4, 2004

(54) System, method, and computer software product for instrument control and data acquisition, analysis, management and storage

(75) Inventors: Derek H. Bernhart, Lafayete Hill, PA (US); Rajindar S. Nijor, Saratoga, CA (US); Shantanu Kaushikkar, San Jose, CA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA

(21) Appl. No.: 10/764,663

(22) Filed: Jan. 26, 2004

Related U.S. Application Data
(63) Continuation-in-part of application No. 10/370,442, filed on Feb. 19, 2003.
(63) Continuation-in-part of application No. 09/683,912, filed on Mar. 1, 2002.
(63) Continuation-in-part of application No. 10/219,882, filed on Aug. 15, 2002.
(63) Continuation-in-part of application No. 09/682,098, filed on Jul. 19, 2001.
(60) Provisional application No. 60/442,684, filed on Jan. 24, 2003.
(60) Provisional application No. 60/483,812, filed on Jun. 30, 2003.

(51) Int. Cl. G06F 7/00

(52) U.S. Cl. 707/1

(57) ABSTRACT

A system is described for providing an interface enabled to transfer data between databases that comprises a database that stores data and is associated with a computer workstation, where the data includes data associated with biological probe arrays; a second database that stores the data that is associated with a server; and an interface that transfers the data between the databases based, at least in part, upon a user selection.

### RELATED APPLICATIONS

This application claims priority to U.S. Provisional Patent Application Ser. No. 60/442,684, titled “System, Method and Computer Software for Instrument Control and Data Acquisition, Analysis, Management and Storage”, filed Jan. 24, 2003; and 60/483,812, titled “System, Method and Computer Software for Instrument Control, Data Acquisition and Analysis”, filed Jun. 30, 2003, each of which is hereby incorporated herein by reference in its entirety for all purposes. This application is also a continuation-in-part and claims priority to U.S. patent application Ser. No. 10/370,442, titled “System and Method for Programmatic Access to Biological Probe Array Data”, filed Feb. 19, 2003; which is a continuation-in-part of U.S. patent application Ser. No. 09/683,912, titled “Software Developers' Kit for Laboratory Information Management System,” filed Mar. 1, 2002; U.S. patent application Ser. Nos. 10/219,882, titled “System, Method, and Computer Software for the Presentation and Storage of Analysis Results” filed on Jul. 15, 2002; and 09/682,098, titled “LIMS 3.0” filed on Jul. 19, 2001, each of which is hereby incorporated herein by reference in its entirety for all purposes.

### COPYRIGHT NOTICE

A portion of the disclosure of this patent document, which includes attached documents specified below, contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

The present invention is related to systems, methods, and computer software products for controlling one or more instrument systems that may perform operations related to biological probe arrays such as sample or array processing, fluid handling, array transport, and/or image acquisition. The present invention is also related to systems, methods, and computer software products for data storage, transfer, analysis, and/or management where the data is related biological probe arrays.

Synthesized nucleic acid probe arrays, such as Affymetrix® GeneChip® probe arrays, and spotted probe arrays, have been used to generate unprecedented amounts of information about biological systems. For example, the GeneChip® Human Genome U133 Set (HG-U133A and HG-U133B) and U133 Plus available from Affymetrix, Inc. of Santa Clara, Calif., is comprised of two microarrays containing over 1,000,000 unique oligonucleotide features covering more than 39,000 transcript variants that represent more than 33,000 human genes. Analysis of expression data from such microarrays may lead to the development of new drugs and new diagnostic tools.

### SUMMARY OF THE INVENTION

There is a demand among users of probe arrays and others for methods and systems for organizing, accessing and analyzing the vast amount of information collected using nucleic acid probe arrays or using other types of probe arrays. These methods may include the use of software applications and related hardware that implement so-called Image Processing applications. Also, there is a need to integrate users' data generation and/or management methods and systems.

A system is described for providing an interface enabled to transfer data between databases that comprises a database that stores data and is associated with a computer workstation, where the data includes data associated with biological probe arrays; a second database that stores the data that is associated with a server; and an interface that transfers the data between the databases based, at least in part, upon a user selection.

In some embodiments, data includes a data file such as a .cel file, a .dat file, a .tif file, a .chp file, or a .spt file. The data may also include a lab data file or a data object. Additionally, each of the databases may implement a data model that, for instance, may define how data is stored and accessed in the databases. For example, the data model includes relational data model such as the AADM data model.

Also in some embodiments, the interface includes a middleware application that may be executed on the workstation or on the server, where the middleware application provides access to the set of one or more data. In some implementations the interface includes a graphical user interface (referred to as a GUI) that displays the data based, at least in part, upon a user selection. For instance the GUI may display an illustrative data tree and/or a graphical illustration of space usage, at least in part, upon a user selection of data. The GUI may also be enabled to transfer a user selection of data interchangeably between each of the databases.

A method for providing a middleware application enabled to transfer data between databases is described that comprises the steps of: providing a database associated with a workstation; providing a database associated with a server; and providing a middleware application, wherein the middleware application performs the step of: transferring data between the databases based, at least in part, upon a user selection, where the data includes data associated with biological probe arrays.

In some embodiments, the middleware application may be executed on the workstation or on the server, and may also further performs the step of: providing access to the data. In some implementations, the access is provided by a graphical user interface, where the graphical user interface displays the data based, at least in part, upon a user selection such as, for instance, from a list of possible data.

A system for providing access security is also described that comprises: a workstation that executes a user request for access to a server that includes a user identity or identifier; a database that provides access information; and a service application that receives the user request and perform the steps of: querying the database based, at least in part, upon the user identity; receiving the access information based, at least in part, upon the user identity; and providing access privileges to the server based, at least in part, upon the access information.

In some embodiments, the service application is associated with the server, and the set of access information includes access to specific files. Also in some implementations, the access privileges include updating the access permission associated with the file. Additionally, the service application further performs the step of: revoking the access privileges based, at least in part, upon user disconnection from the workstation or server.

A system for providing an interface enabled to transfer data between a plurality of databases is described that comprises: a database stored and executed on a workstation; a second database stored and executed on a server; where the workstation stores and executes the interface in system memory. Additionally, the interface performs the step of: transferring a data between the databases based, at least in part, upon a user selection, where the data includes data associated with biological probe arrays.

In some embodiments the interface may include a middleware application or a graphical user interface. In the same or other embodiments, the step of transferring further comprises producing a copy of each of the set of one or more data that may include a copy in what format such as what may be referred to as a .CAB file format. Also in some implementations, the data may be transferred over a network such as the internet.

A computer program product for enabling transfer of a set of one or more data between databases is described, where the computer program product comprises: an interface that transfers the data between a first database and a second database based, at least in part, upon a user selection, where the data includes data associated with biological probe arrays.

In some embodiments, the interface includes a graphical user interface enabled to receive the user selection, and the first database may stored and executed on a computer workstation and the second database may be stored and executed on a server or vice versa.

A method for providing access security is described that comprises the steps of: executing a user request for access to a server; receiving the user request, where the user request includes a user identity or identifier; querying access information based, at least in part, upon the user identity or identifier; and providing access privileges to the server based, at least in part, upon the set of access information.

A system for providing access security is also described that comprises: a workstation that executes a user request for access to a server; a security manager that receives the user request, where the user request includes a user identity or identifier; an access determiner that queries access information based, at least in part, upon the user identity or identifier; and an access provider that provides access privileges for a user to the server based, at least in part, upon the set of access information.

The above implementations are not necessarily inclusive or exclusive of each other and may be combined in any manner that is non-conflicting and otherwise possible, whether they be presented in association with a same, or a different, aspect or implementation. The description of one implementation is not intended to be limiting with respect to other implementations. Also, any one or more function, step, operation, or technique described elsewhere in this specification may, in alternative implementations, be combined with any one or more function, step, operation, or technique described in the summary. Thus, the above implementations are illustrative rather than limiting.

### BRIEF DESCRIPTION OF THE DRAWINGS

The above and further advantages will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 120 appears first in FIG. 1).

FIG. 1 is a functional block diagram of one embodiment of a computer network system including user workstations connected to a GCOS server suitable for execution of GCOS, and GCOS Server software applications in accordance with the present invention;

FIG. 2 is a functional block diagram of the GCOS Server of FIG. 1 including illustrative embodiments of GCOS Server Application, a security service application, and GCOS API's, as well as connections to user workstations and instrument systems;

FIG. 3 is a functional block diagram of one embodiment of a user workstation of FIG. 1 suitable for execution of instrument control and image processing applications;

FIG. 4 is a functional block diagram of one embodiment of a user workstation of FIG. 1 suitable for execution of Data Access Components;

FIG. 5 is a simplified graphical representation of one embodiment of a graphical user interface of the instrument control and image processing applications of FIG. 3 that includes a data tree enabled for user selection of one or more sets of data for backup and data transfer;

FIG. 6 is a simplified graphical representation of one embodiment of a graphical user interface of the instrument control and image processing applications of FIG. 3 that includes the database selection tree enabled for user selection, database usage display, and space allocation pane;

FIG. 7 is a functional block diagram of one embodiment of the security service application of FIG. 2; and

FIG. 8 is a functional block diagram of one embodiment of a method employing the security service application of FIG. 7.

### DETAILED DESCRIPTION

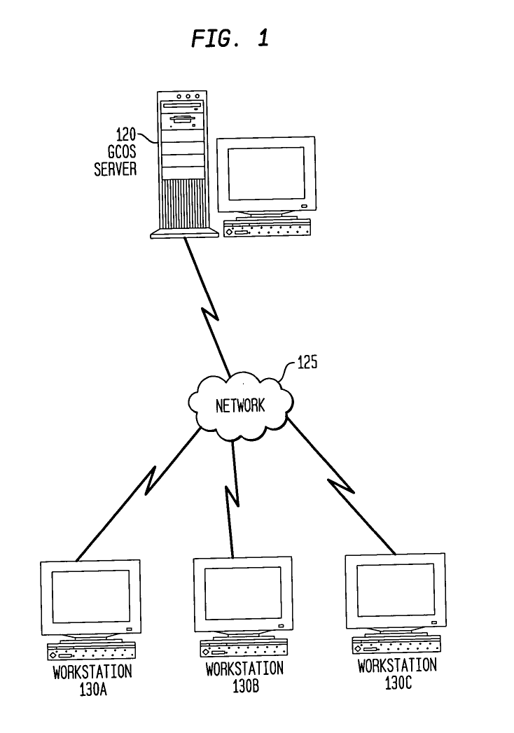

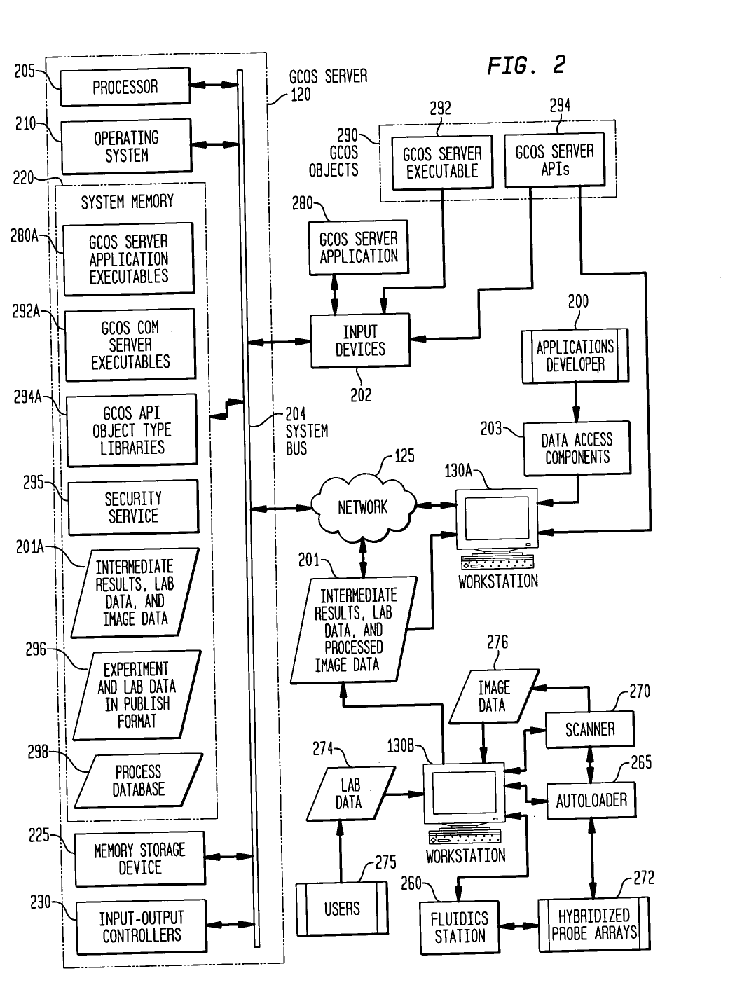

The present invention may be embodied as a method, data processing and/or handling system, computer software program product or products, or any combination thereof. Illustrative embodiments are now described with reference to the computer network system shown in FIGS. 1 through 4. The operations of this computer network system, and of the GCOS and GCOS Server software applications that are executed on computers of this system, are illustrated in the context of generating, processing, and handling of data generated from hybridized probe arrays, such as arrays 272 of FIG. 2. This data generating includes the scanning of arrays 272 by scanner 270 and the processing of the resulting information (and other data) by software executing on representative workstation 130B such as the GCOS software application. Further, data handling and other aspects of management is carried out by the GCOS software application enabled to utilize local and remote resources such as available on GCOS server 120. Each of these elements of FIGS. 2, 3, and 4 are now described in turn.

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3rd Ed., W. H. Freeman Pub., New York, N.Y. and Berg et al. (2002) Biochemistry, 5th Ed., W. H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285 (International Publication Number WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring, and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 60/319,253, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. Patent Application Publication 20030096235), Ser. No. 09/910,292 (U.S. Patent Application Publication 20030082543), and Ser. No. 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2nd Ed. Cold Spring Harbor, N.Y, 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 60/364,731 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2nd ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. US20020183936), 10/065,856, 10/065,868, 10/328,818, 10/328,872, 10/423,403, and 60/482,389.

b) Definitions

An “array” is an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Biopolymer or biological polymer: is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above. “Biopolymer synthesis” is intended to encompass the synthetic production, both organic and inorganic, of a biopolymer.

Related to a bioploymer is a “biomonomer” which is intended to mean a single unit of biopolymer, or a single unit which is not part of a biopolymer. Thus, for example, a nucleotide is a biomonomer within an oligonucleotide biopolymer, and an amino acid is a biomonomer within a protein or peptide biopolymer; avidin, biotin, antibodies, antibody fragments, etc., for example, are also biomonomers. Initiation Biomonomer: or “initiator biomonomer” is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles.

Complementary or substantially complementary: Refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementary exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

Combinatorial Synthesis Strategy: A combinatorial synthesis strategy is an ordered strategy for parallel synthesis of diverse polymer sequences by sequential addition of reagents which may be represented by a reactant matrix and a switch matrix, the product of which is a product matrix. A reactant matrix is a l column by m row matrix of the building blocks to be added. The switch matrix is all or a subset of the binary numbers, preferably ordered, between l and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

Effective amount refers to an amount sufficient to induce a desired result.

Genome is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

Hybridization conditions will typically include salt concentrations of less than about 1M, more usually less than about 500 mM and preferably less than about 200 mM. Hybridization temperatures can be as low as 5.degree. C., but are typically greater than 22.degree. C., more typically greater than about 30.degree. C., and preferably in excess of about 37.degree. C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

Hybridizations, e.g., allele-specific probe hybridizations, are generally performed under stringent conditions. For example, conditions where the salt concentration is no more than about 1 Molar (M) and a temperature of at least 25 degrees-Celsius (° C.), e.g., 750 mM NaCl, 50 mM NaPhosphate, 5 mM EDTA, pH 7.4 (5× SSPE)and a temperature of from about 25 to about 30° C.

Hybridizations are usually performed under stringent conditions, for example, at a salt concentration of no more than 1 M and a temperature of at least 25° C. For example, conditions of 5× SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2nd Ed. Cold Spring Harbor Press (1989) which is hereby incorporated by reference in its entirety for all purposes above.

The term “hybridization” refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.”

Hybridization probes are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

Hybridizing specifically to: refers to the binding, duplexing, or hybridizing of a molecule substantially to or only to a particular nucleotide sequence or sequences under stringent conditions when that sequence is present in a complex mixture (e.g., total cellular) DNA or RNA.

Isolated nucleic acid is an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

Ligand: A ligand is a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

Linkage disequilibrium or allelic association means the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

Mixed population or complex population: refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (mRNA) sequences but still includes some undesired ribosomal RNA sequences (mRNA).

Monomer: refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

mRNA or mRNA transcripts: as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Nucleic acids according to the present invention may include any polymer or oligomer of pyrimidine and purine bases, preferably cytosine, thymine, and uracil, and adenine and guanine, respectively. See Albert L. Lehninger, Principles of Biochemistry, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

An “oligonucleotide” or “polynucleotide” is a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain mRNA molecules and postulated to exist in a triple helix. “Polynucleotide” and “oligonucleotide” are used interchangeably in this application.

Probe: A probe is a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

Primer is a single-stranded oligonucleotide capable of acting as a point of initiation for template-directed DNA synthesis under suitable conditions e.g., buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

Polymorphism refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

Receptor: A molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

“Solid support”, “support”, and “substrate” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

Target: A molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

c) Embodiments of the Present Invention

Hybridized Probe Arrays 272: Illustrated in FIG. 2 is Hybridized Probe Arrays 272. Various techniques and technologies may be used for synthesizing dense arrays of biological materials on or in a substrate or support as described above that may then be exposed to biological samples containing a plurality of target molecules that specifically hybridize to probes disposed upon the array. In some embodiments, one or more methods or steps of processing biological probe array or image acquisition may be carried out by one or more instruments such as, for instance, fluidics station 260, scanner 270 or other type of instrument.

Fluidics Station 260: Illustrated in FIG. 2 is Fluidics Station 260. In some embodiments station 260 implements procedures for introducing one or more fluids to one or more probe arrays in an automated fashion. Particular implementations of fluidics stations that may be included in an embodiment of fluidics station 260 are described in U.S. Pat. Nos. 6,114,122; 6,391623; 6,386,749; 6,422,249; 6,050,719; 6,168,948; U.S. patent application Ser. Nos. 10/684,160; and 10/712,860, each of which are hereby incorporated by reference herein in their entireties for all purposes.

For example, one possible embodiment includes a probe array enclosed in a housing or cartridge. Station 260 could inject the sample into the housing or cartridge through one or more specialized ports. In one implementation a port is provided to import material into the housing or cartridge and another for export. Other implementations could include a single port used for both purposes. In the present example, executables 399A directs station 260 to add a specified volume of fluid to a probe array cartridge. Station 260 removes the specified volume of fluid from a reservoir via a pin, inserts the pin through a designated aperture in the probe array cartridge, and releases the volume of sample. Alternatively, station 260 may insert the loading pin or needle through the import aperture of the probe array cartridge when the user loads the probe array into a particular position. Station 260 may deliver the sample to the pin or needle via tubing, and introduce the sample to the probe array through the pin or needle.

Some embodiments of station 260 may include one or more detection systems under the control of executables 399A capable of detecting the presence of fluid within the housing of a probe array where a detection system may also identify the type or identity of a liquid. For example, the detection system may use what those of ordinary skill in the related art refer to as conductivity or resistance measurements. The term “Conductivity” generally refers to a measure of conductance that refers to the ability of a material to conduct electricity. A variety of factors may affect conductivity, such as the amount of salts or other materials in a liquid. For instance a high salt water solution will be more conductive than distilled water with no mineral content. Solutions can have characteristic conductivity's that may be used for identification purposes.

Additionally, some embodiments of station 260 may provide a means for holding or storing a plurality of experimental samples or other types of fluid. For example, each of the fluids or experimental samples may be contained in one or more removable reservoirs. A reservoir could include a vial, tube, bottle, or some other container suitable for holding volumes of liquid. In the present example, station 260 may provide a holder or series of holders capable of receiving one or more reservoirs. The holder or series of holders may include a tray, carousel, magazine, or other type of holder. Additionally in the present example, each of the reservoirs and/or holders may include one or more unique barcode or other type identifiers generally known to those of ordinary skill in the related art such as, for instance, a magnetic or radio frequency (RFID) type of identifier.

Continuing the example from above, the position, content, or other related information of each of the one or more reservoirs positioned within the holders or series of holders may be communicated by station 260 to the instrument control software such as executables 399A using the one or more identifiers. In the present example, some implementations of station 260 may also provide one or more detectors associated with each position of each holder to indicate to executables 399A when a reservoir is present at a particular position. Executables 399A may instruct station 260 to perform one more operations based, at least in part upon a barcode or other type of identifier associated with one or more probe arrays 272 that may be identified and communicated by station 260 using methods known by those of ordinary skill in the related art, and one or more identifiers related to one or more reservoirs as described above. For instance, executables 399A could associate each of the identifiers with data contained in one or more experiment or other type of data files that could include experiment protocol and parameter information. Executables 399A could then use the data associated with one or more of the identifiers to carry out the operations of station 260.

Autoloader 265: FIG. 2 presents an illustrative example of one possible implementation of an automatic cartridge, housing or biological probe array loader used in conjunction with a scanner such as scanner 270 or fluidics station 260. Embodiments of autoloader 265 may include components enabled to perform operations including probe array transport, environmental control, and lab automation, some specific examples of which are provided below. An implementation of an autoloader that may be included in an embodiment of autoloader 265 is described in U.S. patent application Ser. No. 10/389,194, which is hereby incorporated herein by reference in its entirety for all purposes.

For example, autoloader 265 may include a number of components such as a magazine, tray, or carousel; a transport assembly; a cooled storage chamber; and a warm thermal chamber. One possible implementation of autoloader 265 may include a two piece structure that consists of an upper and a lower section. The upper section could contain components such as a heat exchanger, warming station, and insulated enclosure. The lower structure could contain a transport assembly and electronics. In the present example, autoloader 265 includes a system under the control of executables 399A that performs a method of transporting probe arrays 272, that in some embodiments may be disposed in a cartridge or housing, from a temperature controlled environment into a scanner or fluidics station in an organized and efficient manner, as well as to return probe arrays 272 to the temperature controlled environment following instrument operations.

In one possible embodiment, executables 399A may alter the mode of operation of auto-loader 265 such as, for example, after images from all probe arrays 272 disposed in autoloader 265 have been acquired, executables 399A may switch modes of operation such as, for instance, from a scanning mode to a storage mode. In the present example, executables 399A may directly or indirectly turn off the heating element in the warm thermal chamber, and periodically advance the magazine, tray, or carousel to bring all probe arrays 272 to an equal and cool temperature. User 275 is thus allowed to set up an experiment utilizing a plurality of probe arrays 272 and leave for an extended period without compromising the integrity of the data or biological samples.

Scanner 270: Labeled targets hybridized to probe arrays 272 may be detected using various devices, sometimes referred to as scanners, as described above with respect to methods and apparatus for signal detection. An illustrative device is shown in FIG. 2 as scanner 270. For example, scanners image the targets by detecting fluorescent or other emissions from labels associated with target molecules, or by detecting transmitted, reflected, or scattered radiation. A typical scheme employs optical and other elements to provide excitation light and to selectively collect the emissions.

For example, scanner 270 provides image data 276 representing the intensities (and possibly other characteristics, such as color) of the detected emissions, as well as the locations on the substrate where the emissions were detected. Typically, image data 276 includes intensity and location information corresponding to elemental sub-areas of the scanned substrate. The term “elemental” in this context means that the intensities, and/or other characteristics, of the emissions from this area each are represented by a single value. When displayed as an image for viewing or processing, elemental picture elements, or pixels, often represent this information. Thus, in the present example, a pixel may have a single value representing the intensity of the elemental sub-area of the substrate from which the emissions were scanned. The pixel may also have another value representing another characteristic, such as color. Two examples of image data are data files in the form *.dat or *.tif as generated respectively by Affymetrix® Microarray Suite (described in U.S. patent application Ser. No. 10/219,882, incorporated above) or Affymetrix® GeneChip® Operating Software based on images scanned from GeneChip® arrays, and Affymetrix® Jaguar™ software (described in U.S. Provisional Patent Application No. 60/226,999, incorporated above) based on images scanned from spotted arrays.

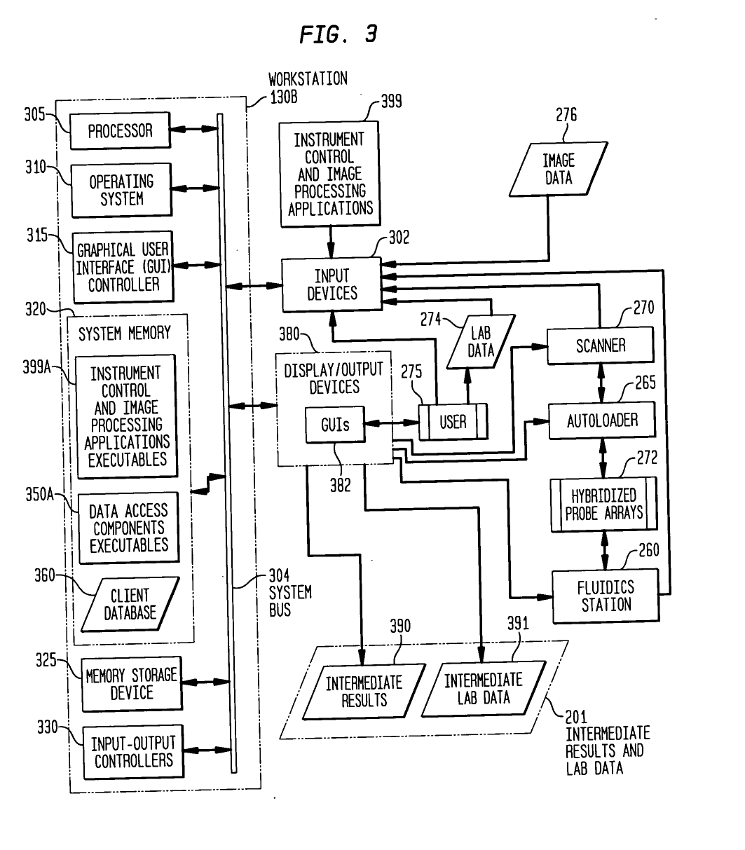

Workstations 130 Image data 276 may be stored and/or processed by a computer system such as any one or more of a number of workstations connected to network 125, generally and collectively referred to as workstations 130. In alternative implementations, image data 276 may be provided by workstations 130, via network 125, to GCOS server 120 where it may similarly be stored and/or processed. An example of workstations 130 is workstation 130B, which is shown in FIG. 2 and, in greater detail, in FIG. 3. Workstation 130B may be any type of computer platform such as a workstation, a personal computer, a server, or any other present or future computer. Workstation 130B typically includes known components such as a processor 305, an operating system 310, a system memory 320, memory storage devices 325, and input-output controllers 330. Each of these known devices is described below in greater detail with respect to corresponding devices of GCOS server 120. In particular, output controllers of input-output controllers 330 could include controllers for any of a variety of known display devices, network cards, and other devices well known to those of ordinary skill in the relevant art. If one of display devices 380 provides visual information, this information typically may be logically and/or physically organized as an array of pixels. Graphical user interface (GUI) controller 315 may comprise any of a variety of known or future software programs for providing graphical input and output interfaces to a user, such as user 275, and for processing user inputs.

Instrument control and image processing applications 399: Instrument control and image processing applications 399 may be any of a variety of known or future image processing applications. Examples of applications 399 include Affymetrix® Microarray Suite, Affymetrix® GeneChip® Operating Software (hereafter referred to as GCOS), and Affymetrix® Jaguar™ software, noted above. Applications 399 may be loaded into system memory 320 and/or memory storage device 325 through one of input devices 302. Applications 399 as loaded into system memory 320 are shown in FIG. 3 as instrument control and image processing applications executables 399A.

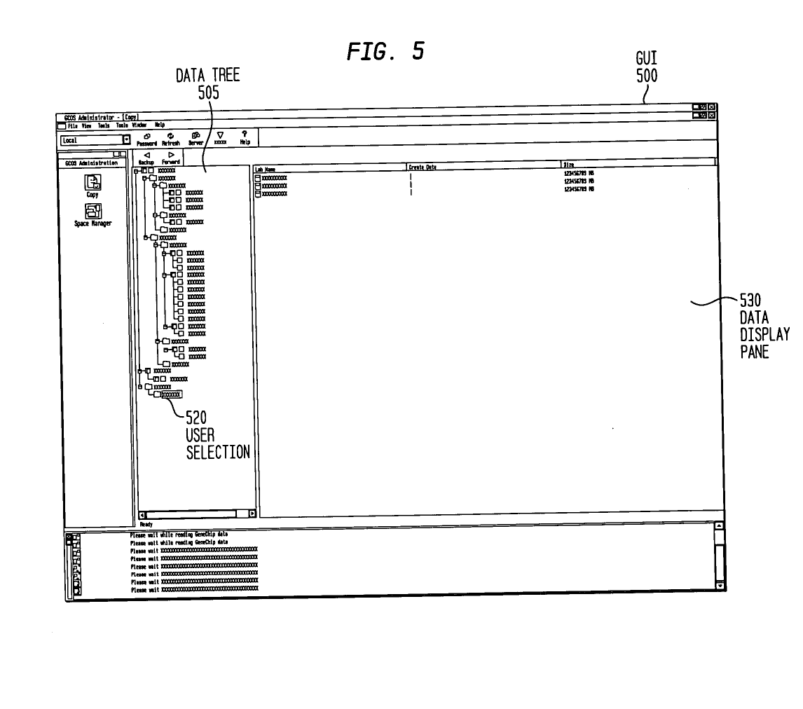

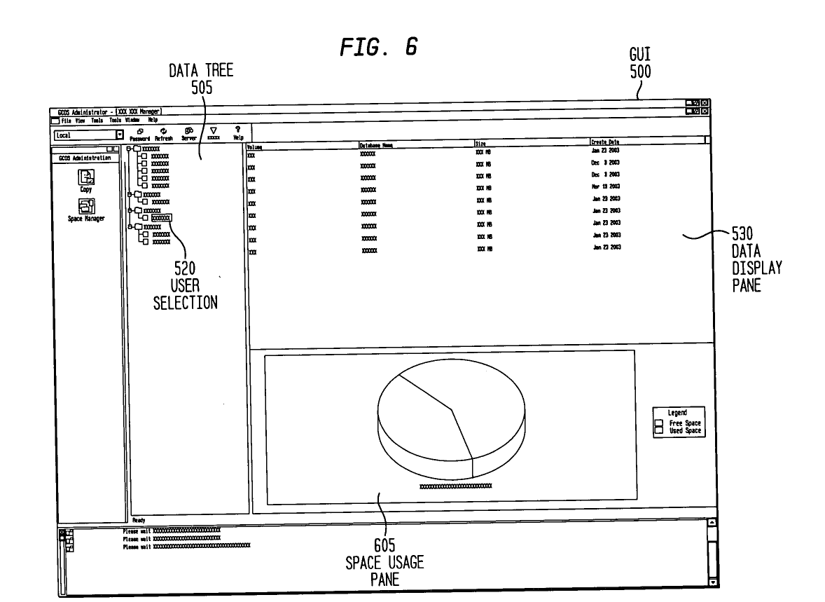

Embodiments of applications 399 includes executables 399A being stored in system memory 320 of an implementation of workstation 130 that includes what is commonly referred to by those of ordinary skill in the related art as a client workstation. Executables 399A may provide a single interface for both the client workstation and one or more servers such as, for instance, GeneChip® Operating Software Server (GCOS Server). Executables 399A could additionally provide the single user interface for one or more other workstations and/or one or more instruments. In the presently described implementation, the single interface may communicate with and control one or more elements of the one or more servers, one or more workstations, and the one or more instruments. In the described implementation the client workstation could be located locally or remotely to the one or more servers and/or one or more other workstations, and/or one or more instruments. The single interface may, in the present implementation, include an interactive graphical user interface that allows a user to make selections based upon information presented in the GUI. An example of such a graphical user interface is presented in FIGS. 5 and 6 as GUI 500. Elements of GUI 500 include one or more user selectable displays such as data tree 505, and one or more panes that display information based, at least in part, upon a user selection such as space usage pane 605.

In alternative implementations, applications 399 may be executed on GCOS Server 120, or on one or more other computer platforms connected directly or indirectly (e.g., via another network, including the Internet or an intranet) to network 125.

Embodiments of applications 399 also include instrument control features. The instrument control features may include the control of one or more elements of one or more instruments that could, for instance, include elements of fluidics station 260, autoloader 265, and scanner 270. The instrument control features may also be capable of receiving information from the one more instruments that could include experiment or instrument status, process steps, or other relevant information. The instrument control features could, for example, be under the control of or an element of the single interface. In the present example, a user may input desired control commands and/or receive the instrument control information via GUI 500.

In the illustrated embodiment of FIG. 3, image data 276 is operated upon by executables 399A to generate intermediate results 390. Examples of intermediate results 390 include so-called cell intensity files (*.cel) and chip files (*.chp) generated by Affymetrix® GeneChip® Operating Software or Affymetrix® Microarray Suite (as described, for example, in U.S. patent application Ser. No. 10/219,882, hereby incorporated herein by reference in its entirety for all purposes) and spot files (*.spt) generated by Affymetrix® Jaguar™ software (as described, for example, in PCT Application PCT/US 01/26390 and in U.S. patent applications Ser. Nos. 09/681,819, 09/682,071, 09/682,074, and 09/682,076, all of which are hereby incorporated by reference herein in their entireties for all purposes). For convenience, the term “file” often is used herein to refer to data generated or used by executables 399A and executable counterparts of other applications, but any of a variety of alternative techniques known in the relevant art for storing, conveying, and/or manipulating data may be employed.

In one of the examples noted above, executables 399A receives image data 276 derived from a GeneChip® probe array and generates a cell intensity file. This file contains, for each probe scanned by scanner 270, a single value representative of the intensities of pixels measured by scanner 270 for that probe. Thus, this value is a measure of the abundance of tagged mRNA's present in the target that hybridized to the corresponding probe. Many such mRNA's may be present in each probe, as a probe on a GeneChip® probe array may include, for example, millions of oligonucleotides designed to detect the mRNA's. As noted, another file illustratively assumed to be generated by executables 399A is a chip file. In the present example, in which executables 399A include Affymetrix® GeneChip® Operating Software, the chip file is derived from analysis of the cell file combined in some cases with information derived from lab data 274 (described below) and library files (not shown) that specify details regarding the sequences and locations of probes and controls. The resulting data stored in the chip file includes degrees of hybridization, absolute and/or differential (over two or more experiments) expression, genotype comparisons, detection of polymorphisms and mutations, and other analytical results.

In another example, in which executables 399A includes Affymetrix® Jaguar™ software operating on image data from a spotted probe array, the resulting spot file includes the intensities of labeled targets that hybridized to probes in the array. Further details regarding cell files, chip files, and spot files are provided in U.S. patent application Ser. Nos. 09/682,098, 09/682,071, and 10/126,468, incorporated by reference above. As will be appreciated by those skilled in the relevant art, the preceding and following descriptions of files generated by executables 399A are exemplary only, and the data described, and other data, may be processed, combined, arranged, and/or presented in many other ways.

User 275 and/or automated data input devices or programs (not shown) may provide data related to the design or conduct of experiments. As one further non-limiting example related to the processing of an Affymetrix® GeneChip® probe array, the user may specify an Affymetrix catalogue or custom chip type (e.g., Human Genome U95Av2 chip) either by selecting from a predetermined list presented by GCOS or by scanning a bar code related to a chip to read its type. GCOS may associate the chip type with various scanning parameters stored in data tables including the area of the chip that is to be scanned, the location of chrome borders on the chip used for auto-focusing, the wavelength or intensity of laser light to be used in reading the chip, and so on. These and other data are represented in FIGS. 2 and 3 as lab data 274. Data 274 may include, for example, the name of the experimenter, the dates on which various experiments were conducted, the equipment used, the types of fluorescent dyes used as labels, protocols followed, and numerous other attributes of experiments. As noted, executables 399A may apply some of this data in the generation of intermediate results 390. For example, information about the dyes may be incorporated into determinations of relative expression. Other (or all) aspects of lab data 274, such as the name of the experimenter, may be processed by executables 399A or may simply be preserved and stored in files or other data structures such as illustrative intermediate lab data 391. These aspects of lab data 274, together with intermediate results 390, are collectively shown as intermediate results and lab data 201 in FIGS. 2 and 3. Data 201 may be provided, via network 125 of this example, to GCOS server 120.

Elements of applications 399 may include what those of ordinary skill in the related art refer to as middleware components that, for example, could include the GeneChip® Data Objects type or GCOS Objects (Described below) type of middleware. In one possible implementation the middleware in the system memory of the client workstation is the same as the middleware on a corresponding database server such as, for example GCOS objects 290 on GCOS server 120, or alternatively some embodiments of the middleware of the client workstation may provide all of the necessary functions for both the client workstation and server as described above. The middleware performs a variety of functions including defining database objects for one or more local databases and controlling how data is saved in the one or more local databases. In some implementations the middleware may be updated for parameters that may include new instrumentation, instrumentation control updates, new assays, or other parameters that may relate to Microarray experiments or instruments. For example, what are commonly referred to by those of ordinary skill in the related art as an application programmers interface (referred to as API's) may be used to dynamically modify the object types without changing or adding any hard coded feature. In the present example, the API's using what is commonly referred to as a library install that could be accessible via CD, internet, or other means of data transfer.

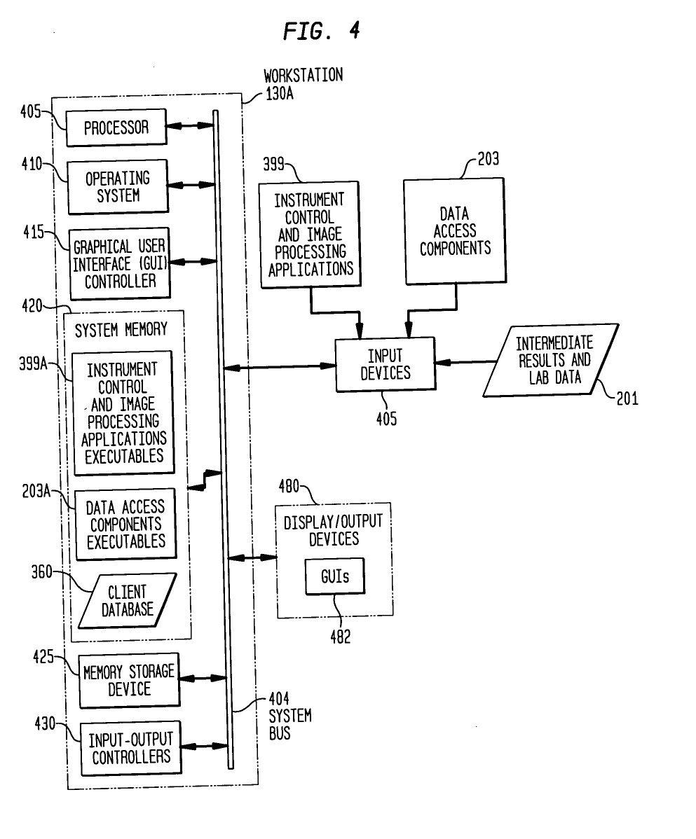

Some embodiments of applications 399 include one or more local databases, an example of which is provided in FIGS. 3 and 4 as client database 360. The functionality and implementation of database 360 includes the same functionality and implementation as the databases associated with GCOS Server 120. Some differences may include the amount of storage capacity or number of users that could be simultaneously supported. An advantage of the presently described implementation includes the ability to move data between the one or more client workstations and the one or more servers seamlessly without any manipulation to the data by a user. For example, a user may move one or more sets of data between workstation 130B and GCOS server 120 via user inputs into GUI 500. For example, GUI 500 may include data tree 505 that provides a graphical illustration of available databases located both on the local client workstation and remotely on another workstation or server. Data display pane 530 may provide information based, at least in part, upon a user selection in data tree 505 such as, for instance, user selection 520. Display pane 530 may also include one or more fields (not shown) that may be enabled to provide a drop down menu of options and receive a user selection, or alternatively be enabled to receive other means of user input such as, for instance, typed in text.

A set of data may include one or more data files or objects as previously described or other types of data. The user may base decisions to move data, at least in part, on various information elements presented to the user in an embodiment of GUI 500 such as, for example, the amount of space used/available space in a particular database graphically displayed in space usage pane 605. In the present example a user may move the one or more sets of data by methods commonly known to those of ordinary skill in the related art such as clicking and dragging icons in GUI 500 manually typing or selecting a destination path from a drop down menu, or other means for selecting and moving sets of data. Continuing with the present example, a user may easily manage and transfer data that is stored both locally and remotely without any requirement on the part of the user for specific knowledge or expertise in database structure or administration.

Some embodiments of applications 399 may enable easily transferable sets of data by producing one or more “backup” versions of each of the sets of data such as, for example, in what may be referred to as a .CAB file format. In the present example, the backup version of each of the sets of data may be employed as an intermediate set of data that may be transferred from the client to the server or vice versa from the server to the client. Thus, there is redundancy of each of the sets of data where applications 399 may update one or more aspects of each of the sets of data either on the source or destination databases or both once the transfer operation has been completed. The update may, for instance, include the deletion of files from the source database once the files have been stored on the destination database.

GCOS Server 120: FIGS. 1 and 2 show a typical configuration of a server computer connected to a workstation computer via a network. For convenience, the server computer is referred to herein as GCOS server 120, although this computer may carry out a variety of functions in addition to those previously described and described further below with respect to GeneChip® Operating Software Server (GCOS Server), Affymetrix® GeneChip® Data Access Components (GDAC), and GeneChip® Operating Software—Software Developers Kit (GCOS-SDK) software applications. Moreover, in some implementations any function ascribed to GCOS Server 120 may be carried out by one or more other computers, and/or the functions may be performed in parallel by a group of computers. Network 125 may include a local area network, a wide area network, the Internet, another network, or any combination thereof.

An illustrative embodiment of GCOS Server 120 is shown in greater detail in FIG. 2. Typically, GCOS server 120 is a network-server class of computer designed for servicing a number of workstations or other computer platforms over a network. However, server 120 may be any of a variety of types of general-purpose computers such as a personal computer, workstation, main frame computer, or other computer platform now or later developed. Server 120 typically includes known components such as a processor 205, an operating system 210, a system memory 220, memory storage devices 225, and input-output controllers 230. It will be understood by those skilled in the relevant art that there are many possible configurations of the components of server 120 and that some components that may typically be included are not shown, such as cache memory, a data backup unit, and many other devices. Similarly, many hardware and associated software or firmware components that may be implemented in a network server are not shown in FIG. 2. For example, components to implement one or more firewalls to protect data and applications, uninterruptable power supplies, LAN switches, web-server routing software, and many other components are not shown. Those of ordinary skill in the art will readily appreciate how these and other conventional components may be implemented.

Processor 205 may include multiple processors; e.g., multiple Intel® Xeon™ 3.2 GHz. As further examples, processor 205 may include one or more of a variety of other commercially available processors such as Itanium® 2 64-bit processors or Pentium® processors from Intel, SPARC® processors made by Sun Microsystems, Opteron™ processors from Advanced Micro Devices, or other processors that are or will become available. Processor 205 executes operating system 210, which may be, for example, a Windows®-type operating system (such as Windows Server 2003, Windows® 2000 with SP 1, Windows NT® 4.0 with SP6a) from the Microsoft Corporation; the Solaris operating system from Sun Microsystems, the Tru64 Unix from Compaq, other Unix® or Linux-type operating systems available from many vendors or open sources; another or a future operating system; or some combination thereof. Operating system 210 interfaces with firmware and hardware in a well-known manner, and facilitates processor 205 in coordinating and executing the functions of various computer programs that may be written in a variety of programming languages. Operating system 210, typically in cooperation with processor 205, coordinates and executes functions of the other components of server 120. Operating system 210 also provides scheduling, input-output control, file and data management, memory management, and communication control and related services, all in accordance with known techniques.

System memory 220 may be any of a variety of known or future memory storage devices. Examples include any commonly available random access memory (RAM), magnetic medium such as a resident hard disk or tape, an optical medium such as a read and write compact disc, or other memory storage device. Memory storage device 225 may be any of a variety of known or future devices, including a compact disk drive, a tape drive, a removable hard disk drive, or a diskette drive. Such types of memory storage device 225 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 220 and/or the program storage device used in conjunction with memory storage device 225.

In some embodiments, a computer program product is described comprising a computer usable medium having control logic (computer software program, including program code) stored therein. The control logic, when executed by processor 205, causes processor 205 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 230 could include any of a variety of known devices for accepting and processing information from a user, whether a human or a machine, whether local or remote. Such devices include, for example, modem cards, network interface cards, sound cards, or other types of controllers for any of a variety of known input or output devices. In the illustrated embodiment, the functional elements of server 120 communicate with each other via system bus 204. Some of these communications may be accomplished in alternative embodiments using network or other types of remote communications.

As will be evident to those skilled in the relevant art, GCOS Server Application 280, as well as GCOS Objects 290 including GCOS Servers 292 and GCOS API's 294 (described below), if implemented in software, may be loaded into system memory 220 and/or memory storage device 225 through one of input devices 202. GCOS server application 280 as loaded into system memory 220 is shown in FIG. 2 as GCOS server application executables 280A. Similarly, objects 290 are shown as GCOS Server Executables 292A and GCOS API object type libraries 294A after they have been loaded into system memory 220. All or portions of these loaded elements may also reside in a read-only memory or similar device of memory storage device 225, such devices not requiring that the elements first be loaded through input devices 202. It will be understood by those skilled in the relevant art that any of the loaded elements, or portions of them, may be loaded by processor 205 in a known manner into system memory 220, or cache memory (not shown), or both, as advantageous for execution.

GCOS Server Application 280: Details regarding the operations of illustrative implementations of application 280 are provided in U.S. patent applications Ser. Nos. 09/682,098 (incorporated by reference above) and 60/220,587, hereby incorporated by reference herein in its entirety for all purposes. It will be understood that the particular GCOS implementation described in this patent application is illustrative only, and that many other implementations may be used with GCOS Objects 290 and other aspects of the present or alternative embodiments.

Application 280, and other software applications referred to herein, may be implemented using Microsoft Visual C++ or any of a variety of other programming languages. For example, applications may also be written in Java, C++, Visual Basic, any other high-level or low-level programming language, or any combination thereof.

As noted, certain implementations may be illustrated herein with respect to a particular, non-limiting, implementation of application 280, sometimes referred to as Affymetrix® GCOS Server. Full database functionality is intended to provide a data streaming solution and a single infrastructure to manage information from probe array experiments. Application 280 provides all the functionality of database storage and retrieval system for accessing and manipulating all system data. A database server provides an automated and integrated data management environment for the end user. All process data, raw data and derived data are stored as elements of the database, providing an alternative to a file-based storage mechanism. A database back end also provides integration of application 280 into a customer's overall information system infrastructure. Data is accessible through standard interfaces, or other type such as the single interface of the present invention previously described with respect to GCOS, and can be tracked, queried, archived, exported, imported and administered.

Application 280 of the illustrated implementation, supports process tracking for a generic assay, adds enhanced administration functionality for managing GeneChip®, spotted array, and AADM data (GeneChip® data that has been published to the AADM data model or standard), provides a full Oracle® database management software or SQL Server solution, supports publishing of genotype and sequence data, and provide a high level of security for the GCOS server system.

Application 280 of the illustrated example provides the following functionality. The Generic assay, supported by process tracking from enhancements to data management. The processes include but are not limited to the following: sample definition, experiment setup, hybridization, scanning, grid alignment, cell intensity analysis, probe array analysis, and publishing. The generic assay supports multiple experiments per sample definition via a re-queuing process, multiple hybridization and scan operations for a single experiment, data re-analysis, and publishing to more than one database. The Process Database, either an Oracle or SQL Server DBMS (Database management system) solution, fully supported by enhancements to CasoAffy (COM Communication layer to the process database). The GeneInfo Database, where enhancements provide additional support for storing chromosome and probe sequence information about the biological item on the probe array. The AADM Database, a database that stores the published GeneChip® data, where enhancements provide full support for either an Oracle® or SQL server DBMS. Additional tables to AADM provide support for genotype data, and modifications to the publishing components include data load performance improvements as well as bi-directional communication with GeneChip® during publishing operations.

Embodiments of Application 280 may also include an implementation of database security that includes a database such as Process database 298 that may provide a role-based security level that is integrated with the Windows NT® user authentication security. Process database 298 supports role definition, functional access within a role and assigning NT groups and users to those roles. A role is a collection of users, which have a common set of access rights to GeneChip® data. Roles are defined per server/database and a role member can be a member of multiple roles, where the software determines a user's access rights. A function is a pre-determined action that is common to all roles. Each role is defined by the functions it can and cannot perform. Functions explicitly describe the type of action that a member of the role can perform. The functions supported by a newly created role includes but is not limited to the following: read process data, delete process data, update process data, archive process data, assume ownership of process data, import, export process data, delete AADM data, create a AADM database, and maintaining roles. When a new user is added to a role they will have access privileges for their data and read only access privilege for other user data within the same role. All non-role members are denied all access privileges to role member's data. When application 280 of the illustrated implementation is installed, at least two roles are created: administration and system user. The installer of the system software is added as a user to the administration role and a selected Windows NT® group is added as a user to the system user role.

Alternatively or in cooperation with the above described security features, an embodiment of the present invention may include an implementation of database security such as what may be referred to as a “File Security” system. One advantage provided by the file security system includes discrete rights assigned to individual users instead of a set of rights assigned to all individuals within an entire group. The file security system includes what may be referred to as a “Declarative” security model that additionally includes what may be called a “Service” such as Security Service 295 that runs on GCOS Server 120. In one possible embodiment, user information or a user identifier contained in a GCOS Server administration database (not shown), Process database 298 or other appropriate database, is used to define role membership. For example, if a user wishes to access GCOS Server 120 the client workstation puts a request into service 295 for the user. Service 295 then checks the appropriate database, such as process database 298, for the users' membership to determine the appropriate file access privileges. In the present example, every user may have a unique set of access privileges for specific files where the access may be defined by specific permissions for each file as opposed to a role based system where a user is assigned to a role with a defined set of access privileges. If the user has the appropriate access permissions, service 295 classifies the user as a “Secured User” and dynamically updates the access permission associated with the particular files on GCOS Server 120 to allow the user to access the appropriate data, else if the user does not have the appropriate access permissions service 295 denies access. In the present example, the secured user access is temporary where access remains only while the user is connected through the client workstation. If the user disconnects, the access privileges are automatically revoked. Additionally, the only way to access the GCOS Server 120 is through security service 295. Some additional advantages of service 295 include the ability to easily update security data such as, for instance, individual users' rights and/or permissions wherein any updates to may be quickly implemented.

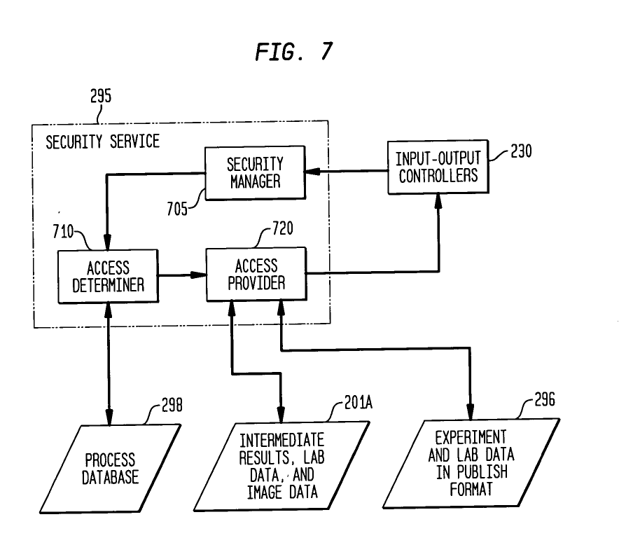

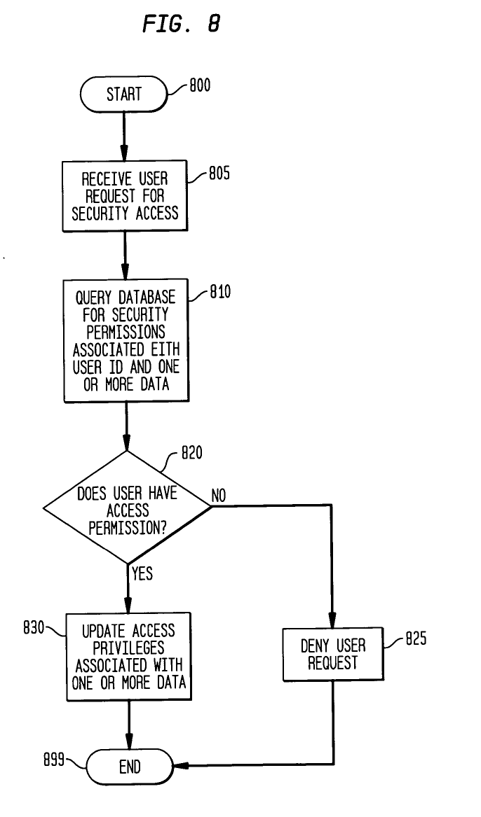

An additional example of security service 295 that may perform the security operations as described above is illustrated in FIG. 7 that includes security manager 705, access determiner 710, and access provider 720, as well as a method that illustrates the steps of one embodiment of security operations is provided in FIG. 8. Step 805 illustrates the step of security manager 705 receiving a user request for security access to one or more sets of data that include data files, objects, or other types of data located on server 120. In the illustrative example the user request includes user identification, one or more identifiers of the one or more sets of data, source of the request such as, for instance, the workstation or network association, time and date of request, and other related information. Security manager 705 then forwards the user request to access determiner 710 that performs one or more queries, as illustrated in step 810, to a database such as process database 298, where the query includes the user identification and the identifiers of the set of one or more of data that the user is requesting access to. Process database 298 returns a result based upon the query that includes the user permissions such as granting or denying access to at least one of the set of one or more data as illustrated in decision element 820. If the user has the appropriate permissions for at least one of the set of one or more data, then access provider 720 updates the data file, object, etc., that may be located in data 201, experiment and lab data in publish format 296 or some other database or means of data storage, to allow the user access as illustrated in step 830. Otherwise, the user may be notified that access was denied to one or more of the set of one or more data, per step 825.

Some embodiments of Application 280 perform operations related to database management operations. For example, one implementation may be referred to as GCOS server Manager, which includes a stand-alone application that provides user management capabilities for GeneChip® Analysis Suite data and AADM databases within the GCOS server system. These capabilities include but are not limited to the following: AADM database creation, publish data deletion, process data deletion, taking ownership of process data, archiving and de-archiving of process data, data export, data import, role management, filter based find, managing expression analysis parameter sets, and managing sample and experiment attribution templates. In a preferred embodiment the operations for the GCOS server manager are performed by the single interface provided by executable 399A implemented on one or more or workstations 130 that, for instance, may include the Affymetrix® GeneChip® Operating Software.

GCOS Objects 290: GCOS Objects 290 is an object oriented programmers interface into GCOS server application 280. In the illustrated embodiment, GCOS objects 290 includes a number of Application Programmers Interfaces (APIs), generally and collectively represented as GCOS API's 294, and a number of GCOS Servers, generally and collectively represented as GCOS Servers Executables 292. GCOS Servers Executables 292 may be distributed as out of process executables (“exe's”) and GCOS API's 294 may be distributed as object type libraries (“tlb's”). It will be understood by those of ordinary skill in the art that various other distribution schemes and arrangements are possible.

GCOS Objects 290 typically may be used by an application developer (represented in FIG. 2 by applications developer 200) who wishes to integrate in-house or third-party software systems with one or more software applications such as GCOS Server Application 280. For example, it is illustratively assumed that applications developer 200 works in an enterprise that employs GCOS Server Application 280 to manage data related to experiments conducted on probe arrays, which may include any type of probe arrays such as GeneChip® probe arrays or spotted arrays (described below and illustratively represented in FIG. 2 as hybridized probe arrays 272). It further is assumed for illustrative purposes that GCOS server application 280 is not a full-service system in that it does not provide functions such as laboratory process scheduling, sample management, instrument control, batch processing, and/or various data mining, processing, or visualization functions. Alternatively, application 280 may provide some or all of these functions, but applications developer 200 may wish to develop alternative or supplementary software applications to perform all or portions of any of these or other functions, and/or to integrate third-party software applications for these purposes. GCOS Objects 290 provides developer 200 with tools to customize both the input of data into, and output of data from, GCOS server application 280.

GCOS Objects 290 includes GCOS Server API's 294. API's 294, in the particular implementation of one or more application programmning interfaces referred to as GCOS COM API's, includes the following classes: loading list of objects, reading an object, updating/writing an object, deleting an object, processing data, creating AADM compliant databases, and for invocation of the analysis controller. API's are also included for objects, which are used by the previously listed classes.

For example, some implementations of API's 294 may allow developer 200 to dynamically update aspects of server software or other related software such as, for instance various types of data objects, without making what those of ordinary skill in the related art refer to as “hardcode” changes such as, for instance, any updates to the middleware software applications. In the present example, the API's allow the update to be performed without further compilation or redistribution of code.

Data Access Components 203: In the illustrated example of FIG. 4, Data Access Components 203 may be stored in system memory 420 as Data Access Components 203A that includes a set of software API's that provide programmatic access to data produced by and/or stored within the instrument control and image processing applications 399. For example one embodiment includes a set of API's referred to as Affymetrix® Genechip® Data Access components (GDAC). These API's hide the format of the files eliminating the need to parse and maintain multiple versions. In the present example, GDAC includes GDAC-Files, GDAC-AADM, and GDAC-Exporter. The API's within GDAC-Files provide access to data stored within the Microarray Suite® data files. These include the CDF (probe set information), EXP (experiment data), DAT (image data), CEL (intensity data), and CHP (analysis results) files. The API's within GDAC-AADM provide access to data stored within an AADM database created by either GCOS or MicroDB such as, for instance client database 360. The API's within GDAC-Exporter provide the capability to export data from the Affymetrix® software systems to MAGE-ML (MicroArray Gene Expression Markup Language) formatted files.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments. For example, some or all of the functions described as being carried out by workstation 130B could be carried out by server 120 and/or workstation 130A, or these functions could otherwise be distributed among these, other local and/or remote computer platforms.

Also, the functions of several elements may, in alternative embodiments, be carried out by fewer, or a single, element. Similarly, in some embodiments, any functional element may perform fewer, or different, operations than those described with respect to the illustrated embodiment. Also, functional elements shown as distinct for purposes of illustration may be incorporated within other functional elements in a particular implementation. Also, the sequencing of functions or portions of functions generally may be altered. Certain functional elements, files, data structures, and so on, may be described in the illustrated embodiments as located in system memory of a particular computer. In other embodiments, however, they may be located on, or distributed across, computer systems or other platforms that are co-located and/or remote from each other. For example, any one or more of data files or data structures described as co-located on and “local” to a server or other computer may be located in a computer system or systems remote from the server. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

What is claimed is:

1. A system for providing an interface enabled to transfer data between a plurality of databases, comprising:
a first database constructed and arranged to store a set of one or more data, wherein the first database is associated with a workstation, and the set of one or more data includes data associated with biological probe arrays;
a second database constructed and arranged to store the set of one or more data, wherein the second database is associated with a server; and
an interface constructed and arranged to transfer the set of one or more data between the first database and the second database based, at least in part, upon a user selection.

2. The system of claim 1, wherein:
the set of one or more data includes a data file.

3. The system of claim 2, wherein:
the data file is a .cel file, a .dat file, a .tif file, a .chp file, or a .spt file.

4. The system of claim 2, wherein:
the data file is a lab data file.

5. The system of claim 1, wherein:
the set of one or more data includes a data object.

6. The system of claim 1, wherein:
the first database and second database includes a data model.

7. The system of claim 6, wherein:
the data model is constructed and arranged to store and provide access to the set of one or more data.

8. The system of claim 7, wherein:
the data model includes a relational data model.

9. The system of claim 8, wherein:
the data model includes an AADM data model.

10. The system of claim 1, wherein:
the interface includes a middleware application.

11. The system of claim 10, wherein:
the middleware application is executed on the workstation.

12. The system of claim 10, wherein:
the middleware application is executed on the server.

13. The system of claim 10, wherein:
the middleware application provides access to the set of one or more data.

14. The system of claim 1, wherein:
the interface includes a graphical user interface.

15. The system of claim 14, wherein:
the graphical user interface displays the set of one or more data based, at least in part, upon a user selection.

16. The system of claim 14, wherein:
the graphical user interface displays a graphical illustration of space usage based, at least in part, upon a user selection.

17. The system of claim 14, wherein:
the graphical user interface enables the user selection of the set of one or more data to transfer.

18. A method for providing a middleware application enabled to transfer data between a plurality of databases, comprising the steps of:
providing a first database associated with a workstation;
providing a second database associated with a server; and
providing a middleware application, wherein the middleware application performs the step of:
transferring a set of one or more data between the first database and the second database based, at least in part, upon a user selection; and
wherein the set of one or more data includes data associated with biological probe arrays.

19. The method of claim 18, wherein:
the middleware application is executed on the workstation.

20. The method of claim 18, wherein:
the middleware application is executed on the server.

21. The method of claim 18, wherein:
the middleware application further performs the step of:
providing access to the set of one or more data.

22. The method of claim 18, wherein:
the access is provided by a graphical user interface, wherein the graphical user interface displays the set of one or more data based, at least in part, upon a user selection.

23. A system for providing access security, comprising:
a workstation constructed and arranged to execute a user request for access to a server, wherein the user request includes a user identity;
a database constructed and arranged to provide a set of access information;
a service application constructed and arranged to receive the user request and perform the steps of:
querying the database based, at least in part, upon the user identity;
receiving the set of access information based, at least in part, upon the user identity; and
providing access privileges to the server based, at least in part, upon the set of access information.

24. The system of claim 23, wherein:
the service application is associated with the server.

25. The system of claim 23, wherein:
the set of access information includes access to specific files.

26. The system of claim 23, wherein:
the access privileges include updating the access permission associated with the file.

27. The system of claim 23, wherein:
the service application further performs the step of:
revoking the access privileges based, at least in part, upon user disconnection.

28. A system for providing an interface enabled to transfer data between a plurality of databases, comprising:
a first database stored and executed an a workstation;
a second database stored and executed on a server; and
wherein the workstation is constructed and arranged to store and execute the interface in system memory, and the interface is constructed and arranged to perform the step of:
transferring a set of one or more data between the first database and the second database based, at least in part, upon a user selection; and
wherein the set of one or more data includes data associated with biological probe arrays.

29. The system of claim 28, wherein:
the interface includes a middleware application.

30. The system of claim 28, wherein:
the interface includes a graphical user interface.

31. The system of claim 28, wherein:
the step of transferring further comprises producing a copy of each of the set of one or more data.

32. The system of claim 31, wherein:
the copy includes a .CAB file format.

33. The system of claim 28, wherein:
the set of one or more data is transferred over a network.

34. The system of claim 33, wherein:
the network includes the internet.

35. A computer program product for enabling transfer of a set of one or more data between a plurality of databases, wherein the computer program product comprises:
an interface constructed and arranged to transfer the set of one or more data between a first database and a second database based, at least in part, upon a user selection; and
wherein the set of one or more data includes data associated with biological probe arrays.

36. The computer program product of claim 35, wherein:
the interface includes a graphical user interface enabled to receive the user selection.

37. The computer program product of claim 35, wherein:
the first database is stored and executed on a workstation and the second database is stored and executed on a server.

38. The computer program product of claim 35, wherein:
the first database is stored and executed on a first workstation and the second database is stored and executed on a second workstation.

39. A method for providing access security, comprising the steps of:
executing a user request for access to a server;
receiving the user request, wherein the user request includes a user identity;
querying a set of access information based, at least in part, upon the user identity; and
providing access privileges to the server based, at least in part, upon the set of access information.

40. A system for providing access security, comprising:
a workstation constructed and arranged to execute a user request for access to a server;
a security manager constructed and arranged to receive the user request, wherein the user request includes a user identity;
an access determiner constructed and arranged to query a set of access information based, at least in part, upon the user identity; and
an access provider constructed and arranged to provide access privileges to the server based, at least in part, upon the set of access information.
